(19) United States
(12) Patent Application Publication
(10) Pub. No.: US 2006/0168377 A1
(43) Pub. Date: Jul. 27, 2006

(54) Reallocation of PCI express links using hot plug event

(75) Inventors: Bharath Vasudevan, Austin, TX (US); Jinsaku Masuyama, Round Rock, TX (US)

Correspondence Address: Ann C. Livingston;Baker Botts L.L.P., One Shell Plaza, 910 Louisiana, Houston, TX, 77002-4995, US

(73) Assignee: Dell Products L.P., Round Rock, TX (US)

(21) Appl. No.: 11/040,987

(22) Filed: Jan. 21, 2005

(51) Int. Cl. G06F 13/00

(52) U.S. Cl. 710/104; 710/316

(57) ABSTRACT

A method and circuitry for reconfiguring the links of a PCI Express bus after a user hot swaps a PCI device. A computer system has been initially configured with PCI Express bus links to various endpoints, using the scaling features of the PCI Express standard. If a hot swap occurs, an SMI routine is used to signal a reconfiguration circuit to reroute unused links (or unused portions of links) to one or more other PCI devices.

### TECHNICAL FIELD OF THE INVENTION

This invention relates to computer systems and more particularly to bus connections for computer systems.

### BACKGROUND OF THE INVENTION

A computer's components, including its processor, chipset, cache, memory, expansion cards and storage devices, communicate with each other over one or more “buses”. A “bus”, in general computer terms, is a channel over which information flows between two or more devices. A bus normally has access points, or places to which a device can connect to the bus. Once connected, devices on the bus can send to, and receive information from, other devices.

Today's personal computers tend to have at least four buses. Each bus is to some extent further removed from the processor; each one connects to the level above it.

The Processor Bus is the highest-level bus, and is used by the chipset to send information to and from the processor. The Cache Bus (sometimes called the backside bus) is used for accessing the system cache. The Memory Bus connects the memory subsystem to the chipset and the processor. In many systems, the processor and memory buses are the same, and are collectively referred to as the frontside bus or system bus.

The local I/O (input/output) bus connects peripherals to the memory, chipset, and processor. Video cards, disk storage devices, and network interface cards generally use this bus. The two most common local I/O buses are the VESA Local Bus (VLB) and the Peripheral Component Interconnect (PCI) bus. An Industry standard architecture (ISA) I/O Bus may also be used for slower peripherals, such as mice, modems, and low speed sound and networking devices.

The current generation of PCI bus is known as the PCI Express bus. This bus is a high-bandwidth serial bus, which maintains software compatibility with existing PCI devices.

### SUMMARY OF THE INVENTION

One aspect of the invention is a method of reallocating links of a PCI Express bus. The status of bus endpoints is detected, such as whether the endpoints are populated and how much bandwidth the endpoints need. Based on this detection, all or a portion of a link having unused bandwidth may be switched to another endpoint. The reallocation is performed as a hot-plug event so that no rebooting is required to activate the reallocation

An advantage of the invention is that it helps to overcome bandwidth limitations of the PCI Express bus. Reconfiguration of PCI Express lanes as a response to a hot-plug event permits unused bandwidth to be switched to other devices on the bus without rebooting.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates various internal elements of an information handling system in accordance with the invention.

FIG. 2 illustrates a portion of the system of FIG. 1, and further illustrates an example of reconfiguring a link.

### DETAILED DESCRIPTION OF THE INVENTION

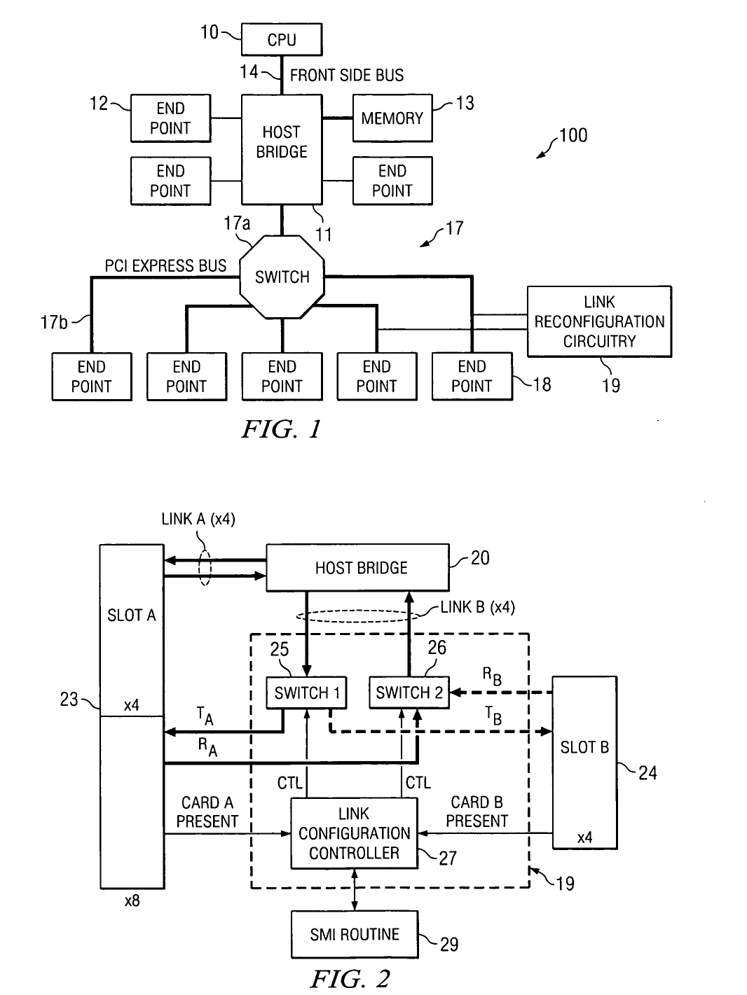

FIG. 1 illustrates various internal elements of an information handling system 100 in accordance with the invention. As explained below, system 100 has a PCI Express bus 17, as well as additional circuitry 19 that dynamically reconfigures one or more links 17b of the bus. PCI Express bus 17 is used in the conventional manner for connecting peripheral components, but is enhanced so that the status of an endpoint 18 may be detected and the bandwidth for that endpoint rerouted if not needed for that endpoint.

In the embodiment of FIG. 1, system 100 is typical of a personal computer system, but could be some other type of information handling system, such as a server, workstation, or an embedded system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, ROM, and/or other types of nonvolatile memory. Additional components of the information handling system may include one or more disk drives, one or more network ports for communicating with external devices, as well as various input and output (I/O) devices, such as a keyboard, a mouse, and a video display. The information handling system may also include one or more buses operable to transmit communications between the various hardware components.

CPU 10 may be any central processing device. An example of a typical CPU 10 is one from the Pentium family of processors available from Intel Corporation. For purposes of the invention, CPU 10 is at least programmed to execute an operating system having BIOS (basic input/output system) programming.

Host bridge 11 (often referred to as a Northbridge) is a chip (or part of a chipset) that connects CPU 10 to endpoints 12, memory 13, and to the PCI Express bus 17. The types of endpoints 12 connected to host bridge 11 depend on the application. For example if system 100 is a desktop computer, endpoints 12 are typically a graphics adapter, HDD (via a serial ATA link), and local I/O (via a USB link). For a server, endpoints 12 are typically GbE (gigabit Ethernet) and IBE devices and additional bridge devices.

Communications between the CPU 10 and host bridge 11 are via a front side bus 14.

PCI Express bus 17 comprises switch fabric 17a and links 17b, by means of which a number of PCI endpoints 18 may be connected. The switch fabric 17a provides fanout from host bridge 11 to links 17b, and provides link scaling.

“Link scaling” means that the available bandwidth of the PCI Express bus 17 is allocated, such that a predetermined number of links 17b, each having a size conforming to PCI Express architecture standards, are physically routed to endpoints 18. Each link 17b comprises one or more lanes. A link having a single lane (referred as having a ×1 width) has two low-voltage differential pairs; it is a dual simplex serial connection between two devices. Data transmission between the two devices is simultaneous in both directions. Scalable performance is achieved through wider link widths (×1, ×2, ×4, ×8, ×16, ×32). Links are scaled symmetrically, with the same number of lanes in each direction.

PCI endpoints 18 may be peripheral devices or chips, physically connected using card slots or other connection mechanisms. The particular endpoints 18 connected to PCI Express bus 17 depend on the type of application of system 100. For a desktop computer system, examples of typical PCI endpoints 18 are mobile docking adapters, Ethernet adapters, and other add in devices. For a server platform, endpoints 18 could be gigabit Ethernet connections, and additional switching capability for I/O and cluster interconnections. For a communications platform, endpoints 18 could be line cards.

In a conventional PCI Express bus 17, the switching fabric 17a is a logical element implemented as a separate component or as part of a component that includes host bridge 11. As explained below, in the present invention, the PCI Express bus 17 operates in conjunction with additional switching and control circuitry 19. This circuitry 19 detects the status of endpoints 18 and is capable of switching links from one endpoint to another.

FIG. 2 is a partial view of system 100, and illustrates physical reconfiguration of PCI Express links 17b in accordance with the invention. Reconfiguration of PCI Express links without the hot-plug aspects of the present invention is described in U.S. patent application Ser. No. 10/702,832, entitled “Dynamic Reconfiguration of PCI Express Links”, assigned to Dell Products, L.P., and incorporated herein by reference.

Each link 17b is illustrated as two pairs of signals—a transmit pair and a receive pair. Transmit pairs are identified as T signals and receive pairs as R signals.

Slots 23 and 24 are designed for connecting card type endpoints 45. Although only two slots are shown, any number of slot configurations are possible depending on the desired scaling (×1, ×4, etc) of the links. Slots 23 and 24 represent physical locations, typically within the computer chassis of system 100, where cards for various I/O devices may be installed. In other embodiments, system 100 could have one or more chip connections in addition to or instead of slot connections. For generality, the term “endpoint connection” could be used to refer collectively to the connection for chips, cards, or any other type of endpoint.

In the example of FIG. 1, slot 23 is configured with a ×4 link width (Link A). Slot 24 is configured with a ×4 link width (Link B).

For purposes of this description, reconfiguration occurs in response to a “hot-swap” event. A “hot-plug” or “hot-swap” event is initiated by a user of system 100, who adds, removes, or exchanges a PCI express card or other end point 18.

As is known, a “hot-swap” or “hot-plug” capability of system 100 permits the user to add and remove devices (endpoints 18) while CPU 10 is running, and to have the operating system automatically recognize the change. Hot swapping is implemented with SMI (system management interrupt) hardware and firmware, which comprises two parts: an interrupt service mechanism and a SMI routine for interrupt servicing. In today's computer systems, these two parts are implemented as hardware and firmware, respectively, however, other implementations are possible. When the user performs a hot-swap, the interrupt hardware sends a signal to the system CPU 10 that runs the BIOS. The SMI routine then executes in the host to service the interrupt and restore the context of the operating system after the interrupt.

In the case of the present invention, a conventional hot-swap SMI routine is modified to signal reconfiguration circuit 19 to perform a physical link reconfiguration. An example of a suitable signaling means is a GPIO pin.

The SMI routine can use various methods to determine which endpoint(s) get how much bandwidth. As one example, a user-defined profile can be accessed. The user-defined profile could be weighted on parameters such as local storage, network I/O, or local graphics. Alternatively, all endpoints 18 could get equal bandwidth. As another example, an adaptive bandwidth allocation could be performed. Bus utilization is recorded and analyzed for the entire PCI Express bus 17. Bandwidth is allocated based on bus utilization history. Various other approaches to bus allocation could be implemented.

Reconfiguration is accomplished using switches 25 and 26 and a link configuration controller 27. It should be understood that FIG. 2 is an example, and many different variations of the switching and control circuitry are possible, with varying numbers of links, slots, and switches, and various link widths.

Link configuration controller 27 may be implemented with a programmable logic device, and may be stand alone logic circuitry or may be integrated with other system logic. For example, link configuration controller could be integrated into host bridge 20.

If signaled by SMI routine 29, controller 27 delivers a signal to switches 25 and 26. Switches 25 and 26 may be implemented with high speed switching devices. Like controller 27, switches 25 and 26 could be integrated with other circuitry, such as with controller 27 and/or with host bridge 20.

In the example of FIG. 2, Link B has a switch 25 on its transmit lanes and a switch 26 on its receive lanes. Switches 25 and 26 are both operable to switch Link B to either slot 23 or slot 24. If Link B is switched to slot 23, slot 23 receives a ×8 link. If Link B is switched to slot 24, slot 24 receives a ×4 link. It is assumed that appropriate physical connections between switches 25 and 26 and slot 23 have been made so that the switching between the alternative paths is possible.

In the example, Slot 23 is now populated and slot 24 is unpopulated. This status is the result of a hot-swap, which has resulted in an SMI routine that has sent a reconfiguration signal to controller 27. In response, controller 27 has set switches 25 and 26 to switch all of Link B to slot 23.

The above example accomplishes “reconfiguration” in the sense that it reroutes existing links, that is, links already been physically routed to various endpoints on the bus. In the absence of the invention, the PCI Express bus would operate in accordance with whatever link configuration was established at initialization of system 100.

What is claimed is:

1. A method of physically reconfiguring links of a PCI Express bus of an information handling system in response to a hot swap, the links being routed to endpoints on the bus, comprising:
using an SMI (system management interrupt) routine to service the hot swap;
wherein the SMI routine generates a link reconfiguration signal;
receiving the link reconfiguration signal at a link reconfiguration circuit; and
switching all or a portion of a link from one endpoint to at least one other endpoint, in response to the receiving step and using the link reconfiguration circuit.

2. The method of claim 1, wherein the link reconfiguration circuit comprises a controller and switches.

3. The method of claim 1, wherein the SMI routine determines to which endpoint(s) the link is to be switched.

4. The method of claim 3, wherein the determination is based on a user-defined profile.

5. The method of claim 3, wherein the determination is based on adaptive bandwidth use analysis.

6. The method of claim 3, wherein the SMI routine further determines how much of the link to switch to each endpoint.

7. Circuitry for reconfiguring links of a PCI Express bus of an information handling system in response to a hot swap, the links being routed to endpoints on the bus, comprising:
an SMI (system management interrupt) routine operable to generate an SMI signal commanding link reconfiguration;
a controller for receiving the SMI signal; and
switches associated with at least one of the links, operable to switch all or a portion of that link from one endpoint to another endpoint, in response to a signal from the controller.

8. The circuitry of claim 7, wherein the SMI routine determines to which endpoint(s) the link is to be switched.

9. The circuitry of claim 8, wherein the determination is based on a user-defined profile.

10. The circuitry of claim 8, wherein the determination is based on adaptive bandwidth use analysis.

11. The circuitry of claim 8, wherein the SMI routine further determines how much of the link to switch to each endpoint.

12. An information handling system capable of allowing “hot swaps”, comprising:
a central processing unit;
memory for storing programming executable by the central processing unit;
a PCI Express bus for connecting input/output endpoints to the system, and having a switch fabric and links from the host bridge to the endpoints;
a host bridge for connecting the CPU, memory, and bus;
an SMI (system management interrupt) routine operable to service hot-swaps and to generate an SMI signal commanding link reconfiguration; and
link reconfiguration circuitry for reconfiguring links of the PCI Express bus, and having a controller for receiving the SMI signal and switches associated with at least one of the links, operable to switch all or a portion of that link from one endpoint to another endpoint, in response to a signal from the controller.

13. The system of claim 12, wherein the SMI routine determines to which endpoint(s) the link is to be switched.

14. The system of claim 13, wherein the determination is based on a user-defined profile.

15. The system of claim 13, wherein the determination is based on adaptive bandwidth use analysis.

16. The system of claim 13, wherein the SMI routine further determines how much of the link to switch to each endpoint.
